(19) United States
(12) Patent Application Publication
(10) Pub. No.: US 2006/0234722 A1
(43) Pub. Date: Oct. 19, 2006

(54) Methods, configuration and computer program having program code means and computer program product for determining a position of a mobile communications device within a communications network

(76) Inventors: Uwe Hanebeck, Grobenzell (DE); Werner Hauptmann, Hohenkirchen (DE); Kai Heesche, Munich (DE); Joachim Horn, Hamburg (DE); Konrad Riegel, Ainring (DE); Klaus Riegel (Erbe), Ainring (DE); Gertraud Riegel (Erbe), Ainring (DE)

Correspondence Address: STAAS & HALSEY LLP, SUITE 700, 1201 NEW YORK AVENUE, N.W., WASHINGTON, DC, 20005, US

(21) Appl. No.: 10/480,103

(22) PCT Filed: Apr. 8, 2003
(86) PCT No.: PCT/DE03/01160

§ 371 Date: Nov. 5, 2004

(30) Foreign Application Priority Data
Apr. 9, 2002 (DE) 102 15 566.6

(51) Int. Cl. H04Q 7/20

(52) U.S. Cl. 455/456.1

(57) ABSTRACT

To determine a position of a mobile communications device within a communications network (localization). possible location areas for the mobile communications device are determined from communications signals of the mobile communications device by using base stations located within the communication network, and these possible location areas are superimposed to form a common location area while using a non-linear quantity-based filter. The position of the mobile communications device is then determined while using the common locations area.

### CROSS REFERENCE TO RELATED APPLICATIONS

This application is based on and hereby claims priority to PCT Application No. PCT/DE03/01160 filed on 8 Apr. 2003 and German Application No. 102 15 566.6 filed on 9 Apr. 2002, the contents of which are hereby incorporated by reference.

### BACKGROUND OF THE INVENTION

The invention relates to determining a position of a mobile communications device in a communications network (localization).

With the increasing spread of mobile communications, the demand for additional services with mobile radio systems is also increasing.

“Location Based Services” in this case is taken to mean additional services of mobile radio providers that users of the mobile radio services can be offered or provided with in a location-based way, i.e., depending on a position or a location of the relevant user. Examples of “Location Based Services” include location-based or distance-based usage tariffs and helping to guide rescue services or search organizations. Consequently, a fundamental requirement for a “Location Based Service” is localization, or determining the position of the relevant user or of their mobile communication terminal.

Various techniques are known for this type of localization of mobile communication devices in communications networks, for example position determination based on determining the delay of communications signals of a mobile communications device to a base station of a communications network (Rappaport T. S., Reed J. H. et al., “Position Location Using Wireless Communications on 16 highways of the Future”, IEEE Communication Magazine, S. 33-41, Oct. 1996, DE 198 36 778 A1 (“the 778 reference”) or a localization using satellite-based systems such as GPS.

The delay-based position determination method known from the 778 reference will be performed for a mobile phone, generally a mobile station, in a GSM communications network (=Global System for Mobile Communications) (Eberspdcher, J.; Vogel, H.-J.: GSM. Global System for Mobile Communication. Stuttgart, Leipzig: Teubner, 1999 (“the Eberspdcher reference”), Jung. P.: Analyse and Entwurf digitaler Mobilfunksysteme. (Analysis and Design of Digital Mobile Radio Systems) Stuttgart, Leipzig: Teubner, 1997 (“the Jung reference”),-Kennemann, 0.: localization vom Mobilstationen anhand ihrer Funkmessdaten. (Localization of mobile stations on the basis of their radio measurement data.) Number 11 in Aachen contributions to mobile and telecommunications. Aachen: Verlag Der Augustinus Buchhandlung, 1997 (“the Kennemann reference”)) in accordance with a TDMA (Time Division Multiple Access) mobile radio technology.

An individual mobile station that has booked in with a fixed base station (base station conducting the call) is assigned a free time slot in a TDMA frame at this base station. The communication signals destined for the mobile station concerned go to this time slot in signal packets, known as bursts, with a length of 15/26 ms from the base station, or the communications signals sent from the mobile station or bursts must arrive at the base station. The communications signals emitted by the base station find their way to the mobile station as results of scattering via different paths (multiple propagation), in which case they will be attenuated depending on frequency.

A receive field strength of the communication signals received by the mobile station is thus not only dependent on the distance of the mobile station from the base station, but also on the frequency and the topographical circumstances between mobile station and base station. Therefore the individual data packets will be sent on various carrier frequencies which means that selective faults of one frequency can be distributed between a pluarality of users. However this requires a precise synchronization between mobile station and base station. This synchronization is also made more difficult by the mobility of a user because the mobile station is now located at differing distances from the base station and its communication signals have different delay times.

To equalize the different delay times and be able to supply frame-synchronous data to the base station, the mobile station measures the signal delay time to the base station and uses this to correct the beginning of sending its burst. The signal delay time is encoded in what is known as a “timing advance” (TA) and features a dependence on the distance between mobile station and base station conducting the call. There are 64 stages available for the TA which are bit-coded with the values 0 to 63 and represent the delay time. Since positions of base stations are known, the position of the mobile station can be deduced from the TA or from the signal delay time. The determination of the delay time is measured with an accuracy of one bit, that is 48/13 μs in GSM, which corresponds to a single path length of around 554 m.

Determining the position of a mobile communications device in a UMTS (=Universal Mobile Telecommunication System) is known from TS 25.305 V3. 1.0: stage 2 “Functional Specification of Location Services in UTRAN” (release 99), 3GPP TSG-RANWG2, 2000. With the corresponding UMTS mobile radio standard, on which the UMTS network is based, determining the position of a mobile radio device is already explicitly included in the Standard or is required by the Standard (TS 25.305 V3.1.0:stage 2 “Functional Specification of Location Services in UTRAN” (release 99), 3GPP TSG-RAN-WG2, 2000).

Further methods for localization of a mobile communications device in a communications network are known from U.S. Pat. No. 5,883,598, U.S. Pat. No. 6,094,168 and U.S. Pat. No. 6,108,553.

A non-linear quantity-based filter is known from U. D. Hanebeck, “Recursive Nonlinear set-Theoretic Estimation Based on Pseudo-Ellipsoids”, Proceedings of the IEEE Conference on Multisensor Fusion and Integration for Intelligent Systems, Baden-Baden, Germany, August 2001, pp. 159-164 (“the Hanebeck reference”). With this non-linear quantity-based filter, complex areas of uncertainty of an N-dimensional original space are transformed into an L-dimensional hyperspace, in which they can be simply represented and processed as ellipsoids. A back-transformation of the processed areas of uncertainty from the hyperspace into the original space allows an analytical description of processed areas of uncertainty in the original space too.

One of the disadvantages of the said localization methods is that the positions of the mobile communications devices that they determine are inaccurate and therefore susceptible to great uncertainty. More precise methods however demand expensive additional equipment and costly modifications to the communications network(s) and communications devices. One potential underlying object of the invention is thus to allow localization of a mobile communications device in a communications network which is as accurate as possible and susceptible to the lowest level of uncertainty, and which can be implemented in the simplest and most cost effective way.

### SUMMARY OF THE INVENTION

The inventors propose a method and a system as well as by a computer program with program code and a computer program product to determine a position of a mobile communications device in a communications network.

In the method for determining a position of a mobile communications device in a communications network with at least one first base station, set up for a first communication with the mobile communications device and a second base station set up for a second communication with the mobile communications device,

a first possible location area of the mobile communications device from the first base station is determined using a first communication signal of the first communication,

a second possible location area of the mobile communications device from the second base station is determined using a second communication signal of the second communication,

the first possible location area and the second possible location area are combined using a non-linear, quantity-based filter, in which case a common location area of the mobile communications device to the first and second base station is determined, and

the position of the mobile communications device is determined using the common location area.

The system for determining a position of a mobile communications device in a communications network with at least one first base station, set up for a first communication with the mobile communications device and a second base station set up for a second communication with the mobile communications device features

a first location area determining unit used by the first base station to determine a first possible location area of the mobile communications device using a first communication signal of the first communication,

a second location area determining unit used by the second base station to determine a second possible location area of the mobile communications device using a second communication signal of the second communication,

a location overlay unit, that combines the first possible location area and the second possible location area using a non-linear quantity-based filter, whereby a common location area of the mobile communications device can be determined for the first and second base station, and

a position determining unit, wherein the position of the mobile communications device can be determined by using the common location area.

The procedure used for the non-linear quantity-based filtering can generally be understood as follows:

the possible location areas are transformed for combination of an original space into a hyperspace,

the possible location areas are combined into a common location area in this hyperspace, and

subsequently, the common location area is transformed back from the hyperspace into the original space.

The advantage of this procedure is that in the hyperspace, the possible location areas transformed into this can be simply described and processed (in this case combined) using prespecifiable bodies.

The computer program with program code is created to execute all the steps as the method for determining a position in accordance with the inventive method, i.e., the localization method, when the program is executed on a computer.

The computer program product with program code means stored on a machine-readable medium is created to execute all the steps as per the localization method when the program is executed on a computer.

The system as well as the computer program with program code, created to execute all steps localization method when the program is executed on a computer, as well as the computer program product with program code stored on a machine-readable medium, created to execute all steps of the localization method when the program is executed on a computer are especially suitable for execution of the localization method or of its developments explained below.

The localization method is based on the idea of obtaining from available communications signals between at least two base stations and a mobile station parameters relevant to distance and from them geographical information, in this case possible location areas or distance or location areas of the mobile station. The location or distance or location areas—and not exact gaps or distances—are produced because the parameters relevant to distances include inaccuracies, such as measurement and computation inaccuracies or model errors, and thereby uncertainties, which result in the said “imprecise” areas, known as areas of uncertainty.

To reduce the uncertainties or the areas of uncertainty to a smaller overall uncertainty or to a smaller area of uncertainty as a possible location area of the mobile station the individual areas of uncertainty are then overlaid. A means from control technology is used, in which for status estimates a plurality of measurements which a subject to uncertainties have to be taken into account, namely a non-linear, quantity-based filter. To overlay the areas of uncertainty with the non-linear, quantity-based filter the individual areas of uncertainty are reduced to a common intersection, the overall area of uncertainty. The mobile station is finally assumed to be in this overall area of uncertainty.

A particular advantage lies in the fact that localization is performed on the basis of communications signals and known positions of base stations that occur in normal operation with a mobile radio system and are available there. This enables expensive changes and expansions as well as additional measurements of existing mobile radio systems or at existing mobile radio systems to be dispensed with.

The developments explained below relate to both the method and the system.

The invention and the developments described below can be realized in both software and hardware, for example using a special electrical circuit. Furthermore, it is possible to realize the developments described below by a computer-readable storage medium on which the computer program with program code means which executes the development is stored. Each development thereof described below can be realized by a computer program product which features a storage medium on which the computer program with program code means which executes the method is stored.

With a communication in a communications network between a mobile communications device (mobile station), for example a mobile phone, and a base station, for example a dish antenna or a dish radiator or of one or more sectoral antennas, data, the (first and the second) communication signals, is transmitted in signal packets, known as bursts.

Various parameters relevant to distance can be determined on the basis of or using the transmitted communication signals, which can then be included in their turn as a basis for determining the possible location or distance areas. This type of parameter which is relevant to, i.e., dependent on distance is, for example, a signal delay time of a signal packet between the mobile station and the base station. The signal delay time exhibits a natural dependence on the distance between the mobile station and the base station (conducting the call) and as a result delivers information about a possible location area or distance area (area of uncertainty) of the mobile station.

The signal delay time can be measured by a mobile station (or also by a base station) and encoded in a timing advance (TA). For the TA 64 coding stages (quantizing stages) can be available which can be (bit-) coded with the values 0 to 63 and represent the delay time. A measurement accuracy in determining signal delay time amounts to a bit duration as a result of quantizing, for example in GSM 48/13 μs, which corresponds there to a simple path length of around 554 m. As a result a measured signal delay time coded in this way leads to a possible area of uncertainty in the form of a ring around the base station with a width that corresponds to the bit duration, for example a 554 m wide ring with GSM. The ring can be restricted to one sector if a direction propagation characteristic of the base station is taken into account. Very frequently there are a plurality of antennas on a base station, which radiate in specific directions and of which one is in communication with the mobile station. With three antennas, for example, a sector of 120° is produced to which the ring can be restricted.

A further parameter of relevance to distance is for example a field strength of a signal packet. The field strength, like the signal delay time, exhibits a natural dependence on the distance between the mobile station and the base station (conducting the call) and as a result supplies information about a possible location area or distance area (area of uncertainty) of the mobile station. This dependence between field and distance can be described by physical models that describe a propagation behavior of signals. If one assumes for such a model an unrestricted propagation of signals, this model supplies a maximum distance for a specified or a measured field strength. Thus, the field strength of a signal packet received by a base station can be measured by the mobile station and from this, by using a propagation model, a maximum gap between the mobile station and the base station can be estimated. This maximum gap can be described by an area of uncertainty in the form of a circle with the corresponding radius around the base station. Here, too, the circle can be restricted to one sector if a radiation direction characteristic of the base station is taken into account. As a result, an area of uncertainty in the form of circle sector is produced.

If a mobile station is now in communication with a plurality of base stations or if it is receiving signal packets from these, a plurality of such areas of uncertainty can be determined, each in relation to the corresponding base station. Thus, it makes sense to include the communication between the mobile station and the base station conducting the call for determination of signal delay time and to determine the corresponding area of uncertainty, the ring sector.

In addition other base stations, at best those received by the mobile station, can each be included for measuring the field strength and the corresponding area of uncertainty, the circle or the circle segment determined in each case. A non-linear, quantity-based filter will be used to combine all areas of uncertainty. With this non-linear, quantity-based filter, complex areas of uncertainty of an N-dimensional original space are transformed into an L-dimensional hyperspace, in which they can be represented and processed, i.e., combined simply, for example by an ellipsoid. To cover all areas of uncertainty it is sensible to form an intersection of all areas of uncertainty, in this case in the hyperspace. As a result of forming the intersection, the non-linear, quantity-based filter delivers a simple-to-describe body such as an ellipsoid, designated as an envelope ellipsoid, in the hyperspace. This envelope ellipsoid fulfills the following conditions:

a) the body is contained in the intersection that can be analytically described by an ellipsoid, and

b) it lies completely in a union of sets of the areas of uncertainty.

The subsequent back-transformation of the envelope ellipsoid from the hyperspace into the original space makes possible an analytical description of the intersection of the areas of uncertainty in the original space as well. It should be noted that bodies other than ellipsoids can also be used to describe the transformed areas of uncertainty in the hyperspace. Furthermore, it is possible to apply the non-linear, quantity-based filter successively or in steps, i.e., two areas of uncertainty are always intersected one after the other. Alternatively the non-linear, quantity-based filter can also be used for simultaneously forming intersections between a plurality of areas of uncertainty in a single step. The position of the mobile station can then be determined using the intersected, back-transformed common areas of uncertainty. To do this a key value of the common area of uncertainty can for example be determined, such as a focus or an expected value, that is then used as an estimate for the position of the mobile station. The method and system are especially suitable for use in the digital, cellular mobile radio systems environment, such as a GSM network, for locating a GSM mobile phone in this area for example. In this case, when the method and system are employed, only data available to the mobile phone is used, which means that expensive changes do not have to be made to either the GSM network or the mobile station in the GSM network. For example, the positions of the individual base stations and their antennas, as well as their characteristics, which provide information about the service area of the antenna involved, are known by a GSM network Prediction maps of field strengths to be expected are determined from environment models and are also available.

The mobile phone, for its part, for a correct connection setup, is always in contact with the receivable antennas in order to have the antenna best suited for a call allocated to it by the network. To do this, it measures such items as the receive field strengths of the receivable antennas as well as defining signal delay times that are then also known. The mobile telephone is then localized on the basis of this available information. Derived from this for the signal delay time are a range of distances of the mobile telephone from its antenna conducting the call arising from a quantization and a maximum possible gap from the field strength measurements. In addition this distance specification can still be restricted to a particular area around the antenna, since directional antennas are involved which for example only supply one sector of 120°. These areas, resulting from the individual measurements, are then reduced using a non-linear quantity-based filter, to the common intersection in which the telephone can be assumed to be according to the model.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a sketch of a GSM network architecture of a GSM mobile radio network;

FIG. 2 is a sketch of a TA area of uncertainty (TA segment);

FIG. 3 is a sketch of field strength areas of uncertainty (RxLev areas);

FIG. 4 is a sketch with a TA segment overlaid with a pluarality of RxLev areas;

FIG. 5 is a sketch of a TA segment created by a non-linear, quantity-based filter;

FIG. 6 is a sketch of an RXLev area created by a non-linear, quantity-based filter;

FIG. 7 is a sketch of a TA segment with RxLev areas formed by a non-linear quantity-based filter.

Exemplary embodiment: localization of a mobile telephone in a GSM network

GSM network architecture of the GSM mobile radio network

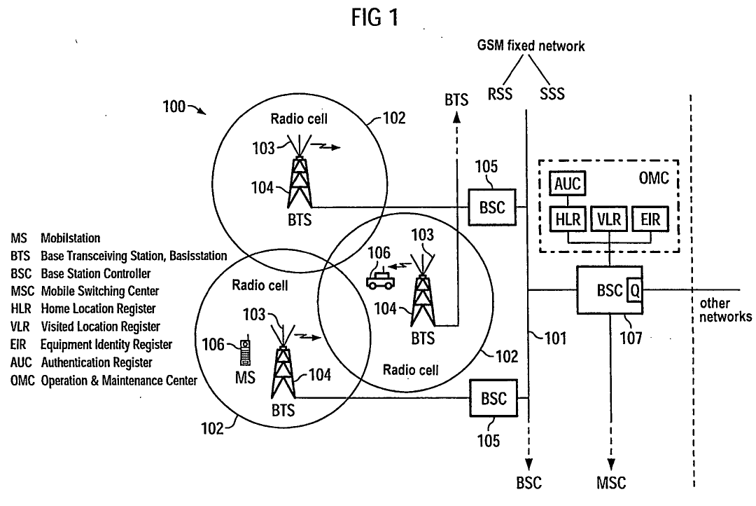

FIG. 1 shows a GSM network architecture 101 of a GSM mobile radio network 100.

This mobile radio network 100 involves a digital, cellular mobile radio system (the Eberspdcher reference, the Jung reference, the Kennemann reference), with a hierarchical structure of a GSM architecture 101 shown in FIG. 1.

An area serviced by an antenna 103 is shown as a cell 102 which will be dimensioned in accordance with the expected number of subscribers.

A base station (BTS) 104 always administers one location, at which however a plurality of sectional antennas 103 can be positioned. If there is only one antenna 103 at a BTS 104 which supplies its entire environment. This is referred to as an omnidirectional antenna.

A plurality of base stations are jointly controlled by a Base Station Controller (BSC) 105. The calls from mobile stations (MS) 106 are connected jointly for their cells 102 by a switching node, the Mobile Switching Center (MSC) 107. For the localization of the mobile stations (MS) 106 in this case the communication between base station 104 and mobile station 106 is especially important.

In order to serve many subscribers with their mobile stations (MS) 106 simultaneously, the GSM network 100 has a cellular structure which allows repetition of frequency bands since only immediately adjacent radio cells 102 may not operate with the same groups of frequencies. Furthermore the 25 MHz bandwidth that is available to a network operator is subdivided into 124 individual channels (carrier frequencies). Finally, eight time-separated call channels are accommodated in this band and operated using time-division multiplexing access. Thus, around 1,000 subscribers can be supplied in one area without frequency band repetition.

Data is transmitted with a time slot in signal packages, known as bursts, with a length of 15/26 ms. The signals emitted by the base station (BTS) 104 find their way to the mobile station (MS) 106 by various paths as a result of scattering (multipath propagation), in which case they will be attenuated depending on frequencies. Thus, the receive field strength of the mobile station (MS) 106 not only depends on its distance from the base station (BTS) 104, but also on its frequency and the topographical circumstances between the sender and the recipient. Therefore the individual data packets will be sent on various carrier frequencies which means that selective faults of one frequency can be distributed between a plurality of users. However, this requires a precise synchronization between mobile station and base station.

This synchronization is made more difficult by the mobility of the subscribers since the mobile stations are now at different distances for the base station and their signals are therefore subject to different delay times. To compensate for this and be able to supply frame-synchronous data to the base station, the mobile station measures the signal delay time to the base station and thereby corrects the start of sending of its data packets. The signal delay time is encoded in what is known as a “timing advance” (TA) and naturally features a dependency on the distance between mobile station and base station conducting the call. Since the coordinates of the base station are known, they allow the position of the mobile station to be deduced. The mobility of the subscribers can also result in the mobile station leaving the service area of a base station and thus in an adjacent base station having to take over the mobile station. This process is referred to as a handover.

To enable the right base station with the best requirements as regards the quality of the connection to be selected, one of the items constantly measured by the mobile station is the field strength of all antennas that can be received. The field strengths of the six antennas with the best reception are notified by the base station conducting the call in what are known as the RxLev values and, taking into account the connection quality and number of subscribers of the other base stations, this base station can then make a handover decision.

The RxLev value in this case contains information about the distance to the other receivable base stations 104, since the field strength reduces with distance, and is thus relevant for the localization of the mobile station (MS) 106. If it were a matter of pure free space propagation, the received power relative to the transmitted power would be expressed by the following equation

$$\frac{{P}_{e}}{{P}_{s}} = {G}_{s} {{G}_{e} ( \frac{c}{4 π rf} )}^{2}$$

with Gₛ and Gₑ standing for the gain of the send or receive antennas respectively, c the speed of light, r the gap between MS-BTS and f the carrier frequency.

Through multipath propagation as a result of reflections at the surface of the earth and reflections from objects or the attenuation for example in buildings this acceptance is no longer, as in a vacuum, proportional to the square of the distance but can reach values up to a factor of 5,
P≈1/rⁿ,nε[3,5],

To design the handover to be synchronous, the first data packet of the mobile station for the new base station conducting the call must arrive at the BTS in the correct time frame. Therefore the mobile station must already know, before the actual handover, such information as the TA value of the next base station conducting the call. To this end, the MS constantly calculates the time difference between the base station conducting the call and the other base stations that can be received. This is referred to as the Observed Time Difference (OTD). The base stations in their turn always have the Real Time Difference (RTD) to their neighbors available and notify the mobile station before a handover of the RTD to the next base station conducting the call. From this RTD and associated OTD, the MS can now calculate the TA value to the next BTS conducting the call BTS, from which in turn conclusions about the MS-BTS distance can be drawn. However this second TA value is only available at the time of the handover and can thus not generally be used for the localization.

Localization parameters in the GSM mobile radio network and their areas of uncertainty

The timing advance (TA) as a measure of the MS-BTS distance and RxLev value as field strength to a maximum of six further base stations are available all the time as localization-relevant parameter to the mobile station. In addition information such as the coordinates of the base stations and the cell centers can be retrieved from the GSM network. However, before the TA or RxLev value can be used for the localization, the dependence on the distance to the relevant base station must be modeled. For the RxLev value, the prediction maps available to the network operators can also be accessed for this purpose. These prediction maps contain the field strength to be expected for a 25m grid.

Timing Advance (TA)

There are 64 stages available for the Timing Advance (TA), encoded with values from 0 to 63 and representing the BTS-MS-BTS delay time. A bit duration of 3.69 μs corresponds in this case to a distance of

$$d = \frac{1}{2} \cdot 3 \text{,} 69 μs \cdot 3 \cdot {10}^{8} \frac{m}{s} = 553 \text{,} 46 m \qquad ( 3 )$$

between BTS and MS. Thus, a maximum distance of around 35 km over the available range of values can be compensated for.

Because of the rounding for the bit-wise specification of the TA value the distance r of the MS to the BTS conducting the call is thus in the quantization interval

$$553 \text{,} 46 m \cdot ( TA - \frac{1}{2} ) \leq r < 553 \text{,} 46 m \cdot ( TA + \frac{1}{2} ) , TA > 0 \\ 0 \leq r < 276 \text{,} 73 m , TA = 0 \qquad ( 4 )$$

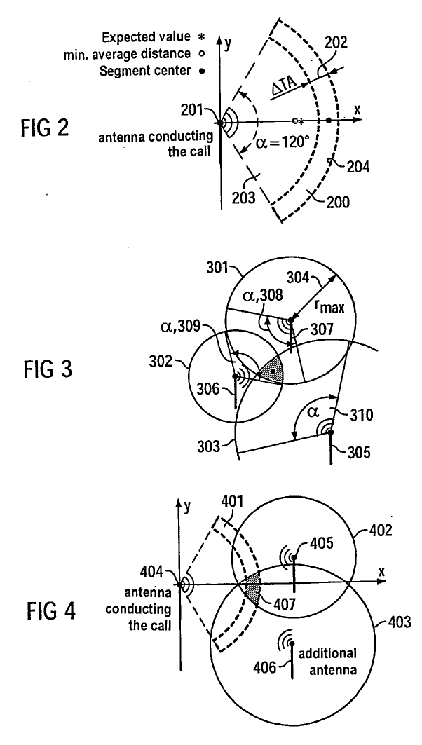

Thus, a ring 200 with a diameter 202 of 553 m around the BTS 201 conducting the call can be derived from the TA value, in which the MS is located. This Ring 200 can, however, depending on the antenna, be restricted even further (to a ring segment 204). Thus, very frequently there are a plurality of antennas on the mast of a BTS, radiating in specific directions. These directions point to the center of the cell of the relevant antenna. With three antennas on the same mast for example a sector 203 of 120° is produced (FIG. 2). Within this TA segment 204 the location area of the mobile station can now be assumed.

RxLev Value

The BTS conducting the call is notified by the MS of the field strengths of the six adjacent BTSs with the best reception so that it can select another BTS for handover. These field strengths are encoded into what are referred to as the RxLev values, which, like the TA value, can be represented in the range of values from 0 to 63. This corresponds to a receive field strength measurement range of −10 dBm to −48 dBm. These RxLev values are now to be converted into a distance to the relevant base station in order to be able to be used for the localization. It should be taken into account here that the RxLev values do not just depend on the MS-BTS distance.

Determining the distance information from the field strength values in accordance with Latapy, J.-M.: GSM mobile station location. Diploma Thesis, Oslo: Norwegian University of Science and Technology, 1996 produces a distance r between mobile station and base station

$$Δ P ( dB ) = 10 \cdot α \cdot log ( \frac{f}{c} ) - 10 \cdot β \cdot log ( 4 π r ) , \qquad ( 5 )$$

with ΔP being the approximation of the field strength, f the carrier frequency, c the speed of light, a a frequency-dependent factor and β a terrain-dependent factor. The receive power falls in this case with the power of 8 of the distance.

Another usable approximation for obtaining the distance is described in Okumura, Y.; Ohmori, E.; Kawano, J.; Fukuda, K.: Field strength and its variability in VHF and UHF Country mobile Service. Review of Electrical Communication Laboratories, Volume, No. 9, P. 825-873, 1968.

As an alternative, a model for determining distances can be derived from field strength measurements. As an approximation, a linear dependence in the form of a straight line between the RxLev values and the MS-BTS spacing is selected. The linear approach is refined in that at least one such straight line per antenna 306, 307, 308 (FIG. 3) is defined for adapting it to its environment. for the maximum distance r_max 304 it thus follows that
r_max=Offset+increase*RxLev (6)

where the parameters Offset and Increase originate from an antenna-specific database or can also be obtained from the prediction maps. It is further assumed that the signals of all obstacles propagate in a circle despite this (FIG. 3), with the distance previously derived from the RxLev values serving as the radius of the circles 301, 302, 303. Thus, in the ideal case, circles 301, 302, 303 are produced as equipotential lines which represent the maximum possible distance for the received field strengths (cf. FIG. 3). In addition, as with the TA value, the directional dependence of the propagation for the sectional antennas 305, 306, 307 can now be taken into account and the circles 301, 302, 303 restricted for example to a 120° segment 308, 309, 310. The location area of the mobile telephone can be assumed to be within the restricted circle segments 308, 309, 310.

Taking into account and combination of the TA and RxLev information

In addition, both the TA segment (401, FIG. 4; FIG. 2) as assumed location of the mobile telephone and also the RxLev circles (402, 403, FIG. 4;FIG. 3) as assumed locations 407 can be included for computing the resulting position of the mobile telephone. In this case the TA segment 401 of the antenna conducting the call 404 is combined with the up to six circles 402, 403 from the field strength measurement to the adjacent base stations 405, 406 (407, FIG. 4). Because of the very simple linear distance model of the field strength, however, the TA-Segment 401 should function as a basis for this combination 407, i.e. forming the intersection of the individual areas.

Filtering or overlaying of the areas of uncertainty using a non-linear, quantity-based filter

The intersection 407 is formed from areas 401, 402, 403 (FIG. 4) using a non-linear, quantity-based filter. Such a non-linear, quantity-based filter is described in the Hanebeck reference. This non-linear, quantity-based filter is a resource from control technology, where for estimating statuses, a pluarality of measurements subject to uncertainty, which can be shown in the form of areas of uncertainty must be taken into account. With the overlaying of the areas of uncertainty by the non-linear, quantity-based filter the individual areas of uncertainty are reduced to a common intersection, an overall area of uncertainty.

To apply the non-linear, quantity-based filter from the Hanebeck reference to the localization problem given above, both the TA ring segment 401 and also each of the RxLev circles 402, 403 are treated as an area of uncertainty of a distance measurement and filtering of the overall area of uncertainty 407 as the assumed location area of the mobile telephone is determined by the non-linear, quantity-based filter.

Basics

The idea with this non-linear, quantity-based filter consists of representing in a simple way the complicated areas of uncertainty of the N-dimensional original space in an L-dimensional hyperspace with L>N.

To this end the points of the original space are mapped into the hyperspace using a non-linear transformation, where the complicated areas can be represented by simple ellipsoids in the following form
X={x:[x−\hat{x}]^{T}(C)⁻¹[x−\hat{x}]≦1} (7)

In this case x is the midpoint vector and C the definition matrix of the ellipsoid.

The non-linear measurement equation of the TA ring can be represented as

$${R}_{i}^{2} \leq {( x - {a}_{x} )}^{2} + {( y - {a}_{y} )}^{2} \leq {R}_{a}^{2} \\ ( \frac{{R}_{a}^{2} + {R}_{i}^{2}}{2} ) = {( x - {a}_{x} )}^{2} + {( y - {a}_{y} )}^{2} + v \qquad ( 8 )$$

with R;, as its inner radius, Ra as its outer radius, ax ay as the coordinates of the antenna and v as the uncertainty of the measurement in a hyperspace (Index *) with status vector
x*=[x, y, x, x, y, x², y²]^{T}=[x₁*, x₂*, x₃*, x₄*, x₅*]^{T} (9)

in linear form

$$( \frac{{R}_{a}^{2} + {R}_{i}^{2}}{2} ) = - 2 {a}_{x} {x}_{1}^{*} - 2 {a}_{y} {x}_{2}^{*} + {x}_{4}^{*} + {x}_{5}^{*} + {a}_{x}^{2} + {a}_{y}^{2} + v \qquad ( 10 )$$

The uncertainty v*=v of the transformed measurement is restricted to the following interval here

$${v}^{*} = [ - ( \frac{{R}_{a}^{2} - {R}_{i}^{2}}{2} ) , ( \frac{{R}_{a}^{2} - {R}_{i}^{2}}{2} ) ] \qquad ( 11 )$$

In general terms it follows for the measurement equation (10) in status variables

$$\begin{matrix}( \frac{{R}_{a}^{2} - {R}_{i}^{2}}{2} ) = [ 2 {a}_{x} , - 2 {a}_{y} , 0 , 1 , 1 ] [ \begin{matrix}x \\ y \\ xy \\ {x}^{2} \\ {y}^{2}\end{matrix} ] + ( {a}_{x}^{2} + {a}_{y}^{2} ) + {v}^{*} \\ {z}^{*} = {H}^{*} {x}^{*} + cf + {v}^{*} , \\ {\hat{z}}^{*} = {H}^{*} {x}^{*} + {v}^{*} , \\ and lastly & ( 12 ) \\ {x}^{m , *} = \{ {x}^{*} : ( {z}^{*} - {H}^{*} {x}^{*} ) ɛ {V}^{*} \} & ( 13 )\end{matrix}$$

which is restricted by the area.

H* is in this case the transmission matrix in hyperspace, x* the status vector and cf a constant correction factor. This is now to be intersected with a prediction area (Index P) which contains all measurements. Finally a limiting ellipsoid (Index s) can be described for the intersection
x^{s}′*=x^{p}′*∩x^{m}′*={x*:[x*−x^{s}′*]^{T}(c^{s}′*)⁻¹[x*−\hat{x}^{s}′*]≦1}, (14)
mit
\hat{x}^{s}′*=\hat{x}^{p}′*+λ*C^{p}′*(H*)^{T}{V*+λ*H*C^{p}′*(H*)^{T}}⁻¹(\hat{z}*−H*\hat{x}^{p}′*) (15)
C^{s}′*=d*p^{s}′* (16)
P^{s}′*=C^{p}′*−λ*C^{p}′*(H*)^{T}{V*+λ*H*C^{p}′*(H*)^{T}}⁻¹H*C^{p}′* (17)
d*=1+λ*−λ*(\hat{z}*−H*\hat{x}^{p}′*)^{T}{V*+λ*H*C^{p}′*(H*)^{T}}⁻¹(\hat{z}*−H*\hat{x}^{p}′*) (18)

Parameter λ serves in this case for weighting of prediction and measurement and can be used to minimize the volume of the limiting ellipsoid.

2*=z*−cf and V* is produced from the square of the maximum uncertainty meaning here for

$${V}^{*} = {( \frac{{R}_{a}^{2} - {R}_{i}^{2}}{2} )}^{2} \qquad ( 19 )$$

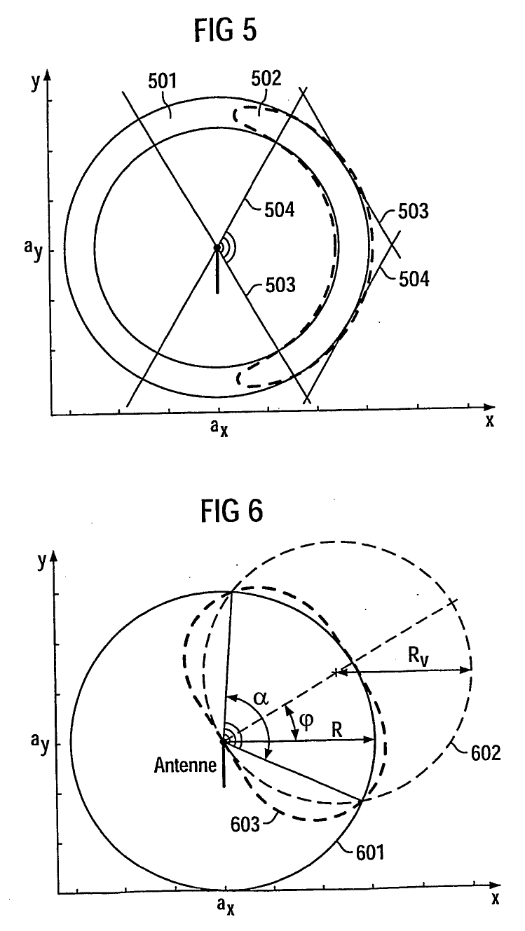

To limit the TA ring 501 created in this way to a 120° sector, as shown in FIG. 2, there is an intersection in the next filter step X^{s′}*, to the prediction area X^{p′}* and this again with two measurements subject to uncertainties in the form of pairs of straight lines 503, 504, which enclose an angle of 120°. Thus, segment 502 in FIG. 5 is recursively produced. The resulting pseudo-ellipsoid Xs′* 502 is a very good approximation of the extent of the ring but still exhibits a significant error with the sector restriction. Therefore, the ellipsoid should either have been narrowed down in an even higher dimensional hyperspace or corrected with a reduction of the angle between the pairs of straight lines.

The exact solution using the extent of the hyperspace has the disadvantage in this case of an disproportionate increase in computing time. With the variation of the angle enclosed by the two pairs of straight lines the sector appears to be able to be better approximated, but the results do not bear this out. Obviously not all measurements lie in the segment assumed by the model, so that a somewhat greater angle area would be better for the measurements. Therefore the approximation in FIG. 9 is retained for the calculations and thus the measurement uncertainties are includes as an approach in the theoretical quantity TA model.

In order to also adapt the model of the field strength measurements to the propagation characteristics of the antenna and thus to restrict the propagation of the signals independent of direction to the radiated antenna sector, a further virtual measurement is introduced here too as an approximation which must then be taken into account recursively via the filter. With the TA segment this occurs via the two pairs of straight lines 503, 504, that is two further measurements.

Another possibility to approximate the restriction for one sector, is offered by the introduction of a second circular measurement, as illustrated in FIG. 6. In this figure, the circles 601 of the maximum possible distance of the RxLev model are intersected with a further circle 602 offset in the direction of radiation.

The circle equation for the offset circle 602 is
Rᵥ²=(x−(aₓ+Rᵥ cos φ))₂+(y−(a_{y}+Rᵥ sin φ))² (20)

with Rᵥ as radius

$${R}_{v}^{2} = \frac{1}{2} \frac{R}{cos ( α / 2 )} \qquad ( 21 )$$

and (aₓ,a_{y}) as coordinates and φ as angle between X-axis and main direction of radiation of the antennas.

From this the non-linear, quantity-based filter again delivers the intersection as a pseudo-ellipsoid 603 taking into account the radiation characteristics of the antenna in the form of the gray approximation in FIG. 6.

Compared to the TA segment, this saves on one filter step. Of course, there would also be the option of creating the TA segment in the same way via an intersection with the offset circle, but this would supply a somewhat worse result. With the RxLev segment on the other hand the approximation of the sector shown is the better choice which might be because of the measurement uncertainties. With the non-linear, quantity-based filter both the TA model and also the RxLev model for directional antennas can be restricted in accordance with their radiation characteristics by approximation to one sector.

The main task of the filters, however, continues to be to record a plurality of measurements with their local restrictions. On the basis of the TA ring which is reduced where necessary to one sector, the further circles of the RxLev measurements can now be taken into account recursively and a pseudo-ellipsoid X^{S′}* encompassing the intersection determined in each case.

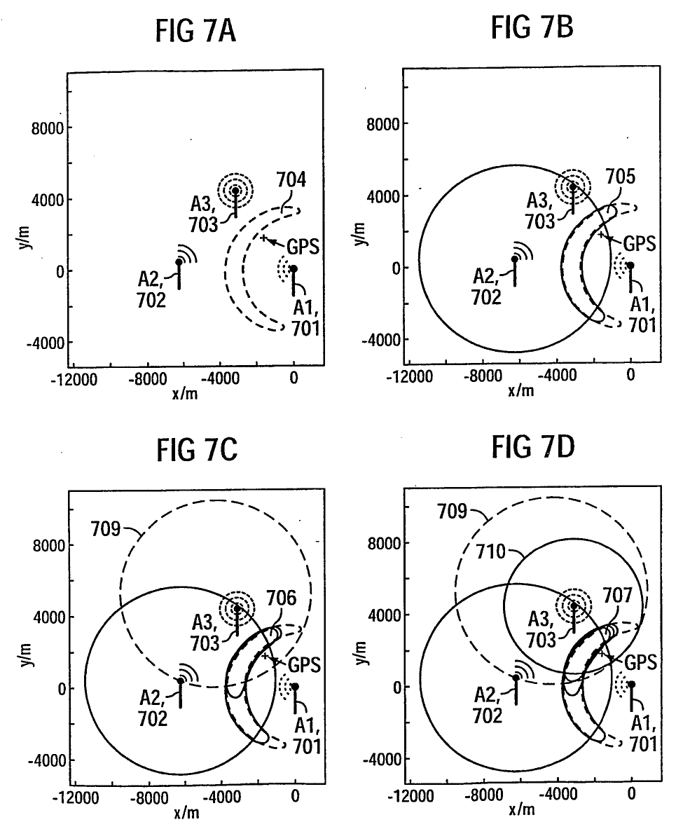

Using an example of an antenna array with 120°-antenna conducting the calls (TA ring segment) and an omnidirectional antenna or a 120° antenna in each case (RxLev measurements), FIG. 7 once more illustrates the procedure of the filter and the successive diminution of the areas of uncertainty (FIG. 7a through 7d, 704-705-706-707).

In this case, A1 701 is the antenna conducting the call with the sectoral TA segment 704 as initial body for forming the intersection. A2 702 is a further, second antenna or base station with a directional characteristic of 120°. A3 is a third omnidirectional antenna with no directional characteristic. With a first section (FIG. 7b) the sectoral TA segment 704 is intersected by a circle 708 as area of uncertainty (still without taking account of the directional characteristics) of the second antenna, which leads to a reduced intersection area 705.

In the next section (FIG. 7c) the directional characteristic of the second antenna 702 is taken into account. This is done using an offset circle 709, as described above. The area 706 is produced as a further reduced intersection area. In the last section (FIG. 7d) there is an intersection with a further circle 710 as area of uncertainty of omnidirectional antenna A3 703. This leads to a further reduction to the area of uncertainty 707.

Position Determination

The aim of localization is to estimate as accurately as possible the position of the mobile telephone from its measurements. To do this, location areas in which an equal distribution is assumed are derived from the measurements. From these areas, the non-linear, quantity-based filter determines an ellipsoid that comprises the intersection of all areas. From this area (FIG. 7d, 707) it is a matter of determining a point which minimizes the average distance over the entire pseudo-ellipsoid of the end area. This can be realized by approximation using a grid, in which the point (x, y) of the grid is selected which minimizes the sum

$$min ( \frac{{\sum }_{i = 1}^{N} \sqrt{( {( \hat{x} - {x}_{i} )}^{2} + {( \hat{y} - {y}_{i} )}^{2} )}}{N} ) \qquad ( 22 )$$

over all N grid points which lie within the final pseudo ellipsoid and which are produced by the numeric evaluation of equation (14). Thus, the point with the minimal average distance to the other points lying within the ellipsoid is selected as the position of the mobile station and result of the localization. To this end the average distance of each of these points must be determined before the minimum of these average distances is available as a result. The search for the minimum of average distances and thereby the computing time can be somewhat restricted by preselecting the points involved. This involves the closer approximation of the average value of the points of the grid lying within the segment, which is also a numeric approximation for the expected value and minimizes the quadratic distance.

The expected value for the TA segment can, however, be determined analytically without the diversion via a grid. If the TA segment is placed for this purpose with a suitable transformation in the coordinate origin symmetrically around the X-axis as in FIG. 2, the expected value is calculated as the position of mobile station by

$${E}_{x} = 2 \cdot d \frac{sin ( α / 2 )}{α} \cdot \frac{12 \cdot {( TA )}^{2} + 1}{( 12 \cdot TA )} , TA ⊳ 0$$

$${E}_{x} = 2 / 3 \cdot d \frac{sin ( α / 2 )}{α} , TA = 0$$

$${E}_{y} = 0.$$

The invention has been described in detail with particular reference to preferred embodiments thereof and examples, but it will understood that variations and modifications can be effected within the spirit and scope of the invention.

1-24. (canceled)

25. A method for determining a position of a mobile communications device in a communications network, comprising:
communicating between a first base station and the mobile communications device using a first communication signal;
communicating between a second base station and the mobile communications device using a second communication signal;
determining a first possible location area for the mobile communications device using a first communication signal;
determining a second possible location area for the mobile communications device from the second communication signal of the second communication;
combining the first possible location area and the second possible location area using a non-linear, quantity-based filter; and
determining the position of the mobile communications device to be a location area common to both the first and second base location areas.

26. The method according to claim 25, wherein the first communication signal and/or the second communication signal is transmitted in the form of data packets.

27. The method according to claim 25, wherein a distance-dependent parameter is determined using the first or the second communication signal, which distance-dependent parameter is dependent on the distance of the mobile communications device to the first or the second base station, wherein said distance-dependent parameter is used to determine the first or the second possible location area.

28. The method according to claim 27, wherein a signal propagation model is used to determine the first or the second possible location area from the distance dependent parameter.

29. The method in accordance with claim 27, wherein the distance-dependent parameter is either a signal delay time of the first or the second communication signal, or a field strength of the first or the second communication signal.

30. The method in accordance with claim 27, wherein the distance-dependent parameter is determined by the mobile communications device.

31. The method according to claim 27, wherein the distance-dependent parameter is encoded.

32. The method according to claim 31, wherein the distance-dependent parameter is bit-coded.

33. The method according to claim 32, wherein the distance-dependent parameter is a timing advance value or a RxLev value.

34. The method in accordance with claim 25, wherein a radiation characteristic of the first or the second base station is taken into account when determining the first or the second possible location area.

35. The method according to claim 34, wherein the radiation characteristic is a directional radiation characteristic.

36. The method in accordance with claim 25, wherein the first possible location area is a ring or a ring sector.

37. The method in accordance with claim 25, wherein the second possible location area is a ring or a ring sector.

38. The method in accordance with claim 25, wherein
the communications network has a plurality of first and/or second base stations,
each base station is set up for communication with the mobile communications device using a corresponding communication signal,
a possible location area is determined for each base station, using the corresponding communication signal, and
all location areas are combined, using the non-linear, quantity-based filters, to determine the position of the mobile communications device.

39. The method according to claim 38, wherein the location areas are combined two at a time.

40. The method according to claim 38, wherein all location areas are simultaneously combined with each other.

41. The method in accordance with claim 38, wherein non-linear quantity-based filtering transforms the possible location areas from an original space into a hyperspace, in which said possible location areas are described using ellipsoidal bodies.

42. The method in accordance with claim 25, wherein non-linear quantity-based filtering transforms the possible location areas from an original space into a hyperspace, in which the possible location areas are combined to form the common location area.

43. The method according to claim 42, wherein the common location area in the hyperspace is described using an ellipsoidal body or an envelope ellipsoid.

44. The method in accordance with claim 25, wherein the common location area is formed where the possible location areas intersect.

45. The method in accordance with claim 25, wherein a focus point or an expected value of the common location is used to determine the position of the mobile communications device.

46. The method in accordance with claim 25, wherein
the communication network is a digital, cellular mobile radio network,
the mobile communications device is a mobile telephone,
the first base station is a base station conducting a call, and
the second base station is another base station that can be received by the mobile telephone.

47. The method in accordance with claim 46, wherein the communications network is a GSM network.

48. The method according to claim 26, wherein a distance-dependent parameter is determined using the first or the second communication signal, which distance-dependent parameter is dependent on the distance of the mobile communications device to the first or the second base station, wherein said distance-dependent parameter is used to determine the first or the second possible location area.

49. The method according to claim 48, wherein a signal propagation model is used to determine the first or the second possible location area from the distance dependent parameter.

50. The method in accordance with claim 49, wherein the distance-dependent parameter is either a signal delay time of the first or the second communication signal, or a field strength of the first or the second communication signal.

51. The method in accordance with claim 50, wherein the distance-dependent parameter is determined by the mobile communications device.

52. The method according to claim 51, wherein the distance-dependent parameter is bit-coded.

53. The method according to claim 52, wherein the distance-dependent parameter is a timing advance value or a RxLev value.

54. The method in accordance with claim 53, wherein a directional radiation characteristic, of the first or the second base station is taken into account when determining the first or the second possible location area.

55. The method in accordance with claim 54, wherein the first possible location area is a ring or a ring sector.

56. The method in accordance with claim 55, wherein the second possible location area is a ring or a ring sector.

57. The method in accordance with claim 56, wherein
the communications network has a plurality of first and/or second base stations,
each base station is set up for communication with the mobile communications device using a corresponding communication signal,
a possible location area is determined for each base station, using the corresponding communication signal, and
all location areas are combined, using the non-linear, quantity-based filters, to determine the position of the mobile communications device.

58. The method according to claim 57, wherein the location areas are combined two at a time.

59. The method according to claim 57, wherein all location areas are simultaneously combined with each other.

60. The method in accordance with claim 57, wherein non-linear quantity-based filtering transforms the possible location areas from an original space into a hyperspace, in which said possible location areas are described using ellipsoidal bodies.

61. The method in accordance with claim 60, wherein non-linear quantity-based filtering transforms the possible location areas from an original space into a hyperspace, in which the possible location areas are combined to form the common location area.

62. The method according to claim 61, wherein the common location area in the hyperspace is described using an ellipsoidal body or an envelope ellipsoid.

63. The method in accordance with claim 62, wherein the common location area is formed where the possible location areas intersect.

64. The method in accordance with claim 63, wherein a focus point or an expected value of the common location is used to determine the position of the mobile communications device.

65. The method in accordance with claim 64, wherein
the communication network is a digital, G5M cellular mobile radio network,
the mobile communications device is a mobile telephone,
the first base station is a base station conducting a call, and
the second base station is another base station that can be received by the mobile telephone.

66. A system to determine a position of a mobile communications device in a communications network having a first base station to communicate with the mobile communications device using a first communication signal, and having a second base station to communicate with the mobile communications device using a second communication signal, the system comprising:
a first location determining unit used by the first base station to determine a first possible location area for the mobile communications device using the first communication signal;
a second location determining unit used by the second base station to determine a second possible location area for the mobile communications device using the second communication signal;
a location overlay unit that combines the first possible location area and the second possible location area using a non-linear quantity-based filter, and that determines a common location area; and
a position determining unit to determine the position of the mobile communications device using the common location area.

67. A computer readable medium storing a program to control a computer to perform a method for determining a position of a mobile communications device in a communications network, the method comprising:
communicating between a first base station and the mobile communications device using a first communication signal;
communicating between a second base station and the mobile communications device using a second communication signal;
determining a first possible location area for the mobile communications device using the first communication signal;
determining a second possible location area for the mobile communications device from the second communication signal;
combining the first possible location area and the second possible location area using a non-linear, quantity-based filter; and
determining the position of the mobile communications device to be a location area common to both the first and second base location areas.
